(19) United States
(12) Patent Application Publication
(10) Pub. No.: US 2011/0291323 A1
(43) Pub. Date: Dec. 1, 2011

(54) METHOD AND APPARATUS FOR POSITIONING A CONDUIT GUIDE IN A MOLDABLE MATERIAL PRIOR TO POURING THE MATERIAL INTO A FORM

(75) Inventor: Robert C. GRASSER, Reinholds, PA (US)

(73) Assignee: HIGH CONCRETE GROUP LLC, Lancaster, PA (US)

(21) Appl. No.: 13/108,141

(22) Filed: May 16, 2011

Related U.S. Application Data
(60) Provisional application No. 61/347,886, filed on May 25, 2010.

(51) Int. Cl. B29C 39/44; E04C 5/20

(52) U.S. Cl. 264/278; 52/677

(57) ABSTRACT

A positioner to secure a conduit guide in a cement pouring form for forming a concrete structural member. The positioner includes a body having a surface portion configured and positioned to support a corresponding surface portion of the conduit guide in the form. A first ferromagnetic member is associated with the body. The body selectably secures the conduit guide in the form without requiring a fastener.

### RELATED APPLICATION

This application claims priority to U.S. Provisional Patent Application Ser. No. 61/347,886, filed May 25, 2010, entitled “Method And Apparatus For Positioning A Conduit Guide In A Moldable Material Prior To Pouring The Material Into A Form.”

### FIELD

The disclosure relates to a device and method for positioning conduit guide members in moldable building materials. More particularly, the present disclosure is directed a positioner and a method for positioning conduit guides in cement pouring forms, and more specifically to selectably positioning conduit guides in the pouring form, which upon curing, become concrete structures.

### BACKGROUND

Conduit guides have been used in concrete structural members, such as structural tees, panels, and connections between girders and columns to help assemble or reinforce the structural members together. Additionally, such conduit guides can provide convenient access for routing non-structural components, such as electrical wiring or plumbing. These conduit guides are placed in the cement pouring forms prior to pouring the cement, displacing cement that is poured in the cement forms to provide the desired passageways in the resulting concrete structural members.

Unfortunately, in order for the conduit guides to remain in a desired position within the pouring form during the fabrication process, i.e., during and subsequent to pouring the cement, the conduit guides must be fastened to the pouring form. Mechanical fasteners such as screws or nails are driven/inserted through both the conduit guide and into pouring forms composed of wood. For pouring forms composed of metal, a combination of wire mesh and tension cables are embedded in the form, and multiple lengths of wire are utilized to secure the conduit guide to the wire mash and tension cables. Among the drawbacks associated with the use of such fasteners are the time, effort and materials expended during the installation and/or removal of the fasteners, as well as additional wear that must be withstood by the pouring forms into which the fasteners are driven, which may reduce the life of the forms. Additionally, the fasteners are not re-usable, as they become incorporated into the poured concrete structural member. Further, once the conduit guide has been fastened in the form, but prior to the cement pour, relocation of the conduit guide is a cumbersome task.

What is needed is a conduit guide that can be positioned/repositioned for use with pouring forms that does not require mechanical fasteners to secure the conduit guide to the pouring form.

### SUMMARY

The present invention relates to a positioner to secure a conduit guide in a cement pouring form for forming a concrete structural member. The positioner includes a body having a surface portion configured and positioned to support a corresponding surface portion of the conduit guide in the form. A first ferromagnetic member is associated with the body. The body selectably secures the conduit guide in the form without requiring a fastener.

The present invention further relates to a method of positioning a conduit guide in a pouring form including providing a positioner having a body and a surface portion, the body associated with a first ferromagnetic member. The method further includes selectably positioning the surface portion of the body and a surface portion of the conduit guide to support the conduit guide in the form without requiring a fastener.

The present invention yet further relates to a positioner to secure a conduit guide in a cement pouring form for forming a concrete structural member. The positioner includes a body having at least one surface portion, each surface portion configured and positioned to support a corresponding surface portion of the conduit guide in the form, the corresponding surface portions opposed to each other. A first ferromagnetic member is associated with the body. The body selectably secures the conduit guide in the form without requiring a fastener; wherein the body is reusable.

An advantage is a conduit guide for use with pouring forms can be positioned/repositioned to the pouring form without the use of mechanical fasteners to secure the conduit guide.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 is a top perspective view of a structural member manufactured using the present disclosure.

FIG. 2 is an enlarged, partial cross sectional view of a conduit guide and positioner of FIG. 1.

FIG. 3 is an alternate embodiment of an enlarged, partial cross sectional view of a conduit guide and positioner of FIG. 1.

FIG. 4 is an exploded view of a conduit guide and a positioner prior to assembly to each other.

FIG. 5 is an end view of a conduit guide and a positioner subsequent to assembly to each other.

FIG. 6 is an enlarged, partial elevational view of an alternate embodiment of a positioner for use with a conduit.

FIG. 7 is an end view of the positioner of FIG. 6.

FIG. 8 is a prior art arrangement to secure a conduit guide.

FIG. 9 is an exploded view of a conduit guide and a positioner prior to assembly to each other.

FIG. 10 is an end view of a conduit guide and a positioner subsequent to assembly to each other.

Wherever possible, the same reference numbers will be used throughout the drawings to refer to the same or like parts.

### DETAILED DESCRIPTION OF THE INVENTION

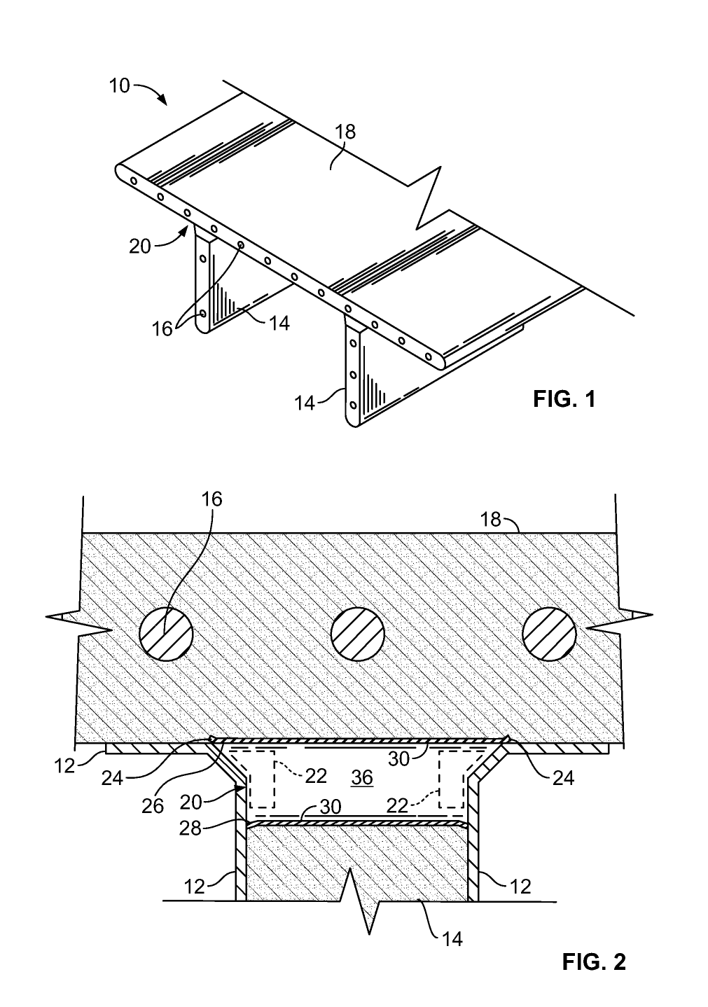

Referring to FIGS. 1-2, the present disclosure is directed to an apparatus and/or method for positioning a conduit guide 20 in a form 12 into which material is poured, and upon curing of the material, produces a product 10. In an exemplary embodiment, the material to be poured in the form is cement (forming concrete upon curing), and the product formed is a concrete structural member, such as a Tee beam, also referred to as a T-beam or double Tee block (shown in FIG. 1), panels or connections between girders and columns.

The term positioning is distinguishable from fastening, in that a fastener is typically inserted through at least one, and more typically, through both the form and the conduit guide (in the case of wood forms), in order to secure the conduit guide in position during the curing process. In addition, a fastener must typically be removed by a tool usable for that purpose, i.e., not manually performed, or if the fastener is not removed, material of the conduit guide securing the fastener to the form must typically be torn through or removed. An example of the latter situation is disclosed in FIGS. 23-26 of Applicant's invention application Ser. No. 11/428,657, which is incorporated by reference in its entirety. A further distinction between positioning and fastening concerns the ease associated with selectively moving or repositioning the conduit guide in the form, i.e., without the need to remove the installed fastener, typically inserted or driven into or through at least one of the form or the conduit guide (in the case of wood forms). A yet further distinction between positioning and fastening concerns the reusability aspect, which a “positioner” is configured to achieve, without insertion of the positioner into a surface of the form or the conduit guide, permitting the positioner to be re-used many times. In the case of metal forms, the positioner is secured to the pouring form without the need for support by wires that are secured to components embedded within the form. Further, the wires used to secure conduit guides are similarly embedded in the form, becoming a part of the concrete structure. Use of pre-existing recesses or protrusions formed in the pouring form may also be distinguished from the positioner of the present disclosure in that such pre-existing features are located at fixed positions in the form and thus place constraints on selective movement or repositioning of the conduit guide not imposed by the positioner of the present disclosure, not to mention the additional costs associated with adding such features to the forms.

For purposes herein, the terms Tee beam, T-beam, beam or double Tee block may be used interchangeably.

FIG. 1 shows a cast concrete T-beam 10 having an essentially flat supporting top panel 18 and a pair of dependent legs 14 extending downwardly from the panel. Reinforcing tension cables 16 may be embedded in the beam as shown.

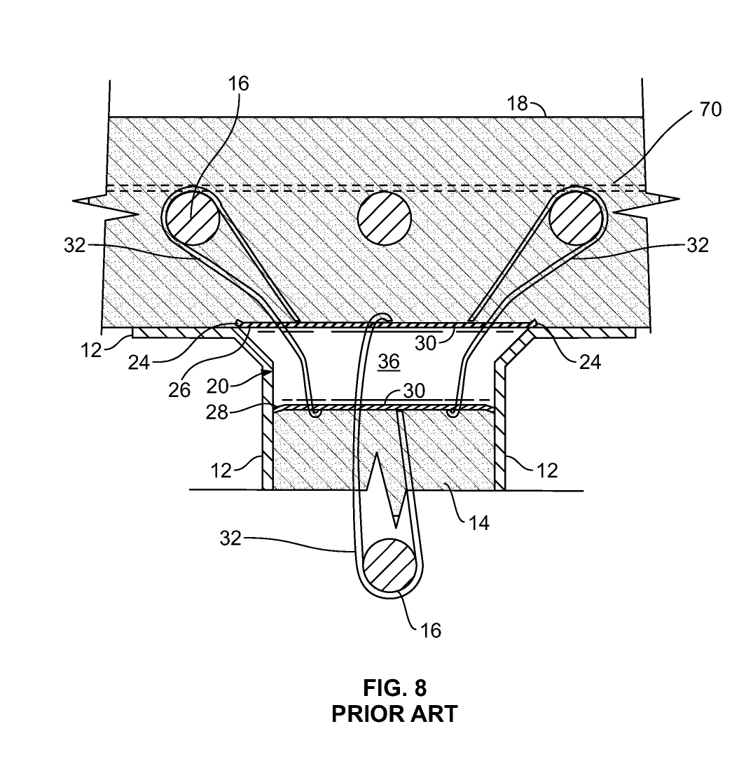

T-beams 10 are cast using a mold or form defining the shape of the legs and the lower surface and sidewalls of the top panel. FIG. 2 illustrates the portion of the form 12 at the top of one leg 14 or the knee junction with the top panel. Cables 16 are rigged and guides 20 are positioned in the knee portions of the form at intervals along the length of the legs where openings will be required in the completed beam for utility wires, conduits, water lines, and the like. FIG. 2 further shows positioners 22 located near ends of guide 20 to substantially prevent movement of the guide in form 12 without the need for fasteners, as will be discussed in further detail below. As shown in FIG. 8, which represents the known art, a mesh 70 is embedded in top panel 18 and supported by tension cables 16. Multiple sets of wire 32 may be secured to the mesh and/or the tension cables in order to secure conduit guide 20 in position. The present disclosure does not require mesh 70 or wires 32.

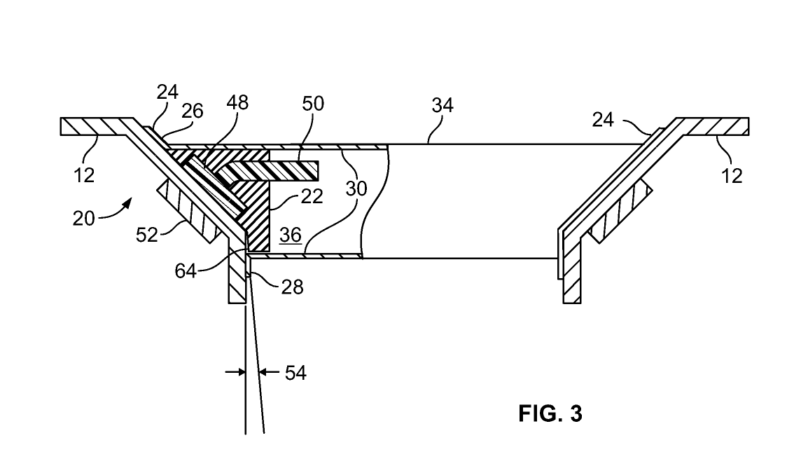

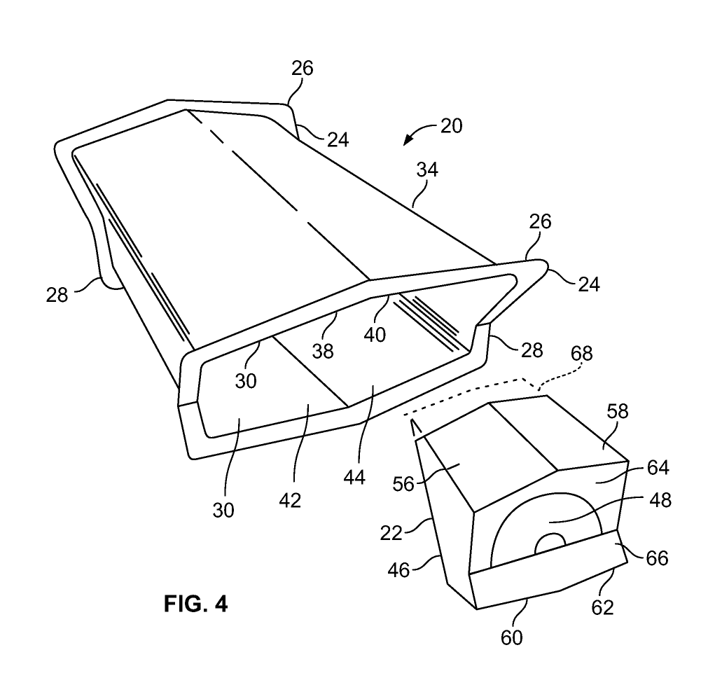

Guides 20 are placed in the empty forms as shown in FIGS. 2-3. Guides 20 include a body 34 having an interior surface 30 defining a passage 36 extending between opposed flanges 24 abutting with the interior surfaces of the form to create an effective seal between the guide and form to prevent liquid cement from flowing into the guide. In one embodiment, an upper portion 26 of flange 24 may be spaced a slight distance above form 12. However, the concrete is too viscous to flow through the small opening. A lower portion 28 of flange 24 is compressed against the form and retains the guide in place in the form. As further shown in an exemplary embodiment shown in FIG. 4, upper portion 26 and lower portion 28 of flange 24 extend toward each other and form a contiguous seal along the periphery of each end of guide 20. In an alternate embodiment, the guide may include only one flange 24, and may utilize a second guide that is interconnected to the first guide by a length of tubing, such as polyvinyl chloride (PVC) tubing or other suitable material. An example of such a guide construction is also disclosed in Applicant's previously mentioned invention application Ser. No. 11/428,657. In either construction, upon installation of guide 20 in form 12, upper and lower portions 26, 28 of flange 24 conform to the corresponding curved and/or straight portions of the form to provide an effective seal, substantially preventing liquid cement from entering guide 20. Prior to guide 20 being positioned in form 12, a positioner 22 is inserted in opposed ends of the guide, to substantially prevent movement of guide 20 in the form during the cement pour.

With the cables 16 and guides 20 in place, the form 12 is filled with liquid cement up to the level of the top of panel 18. Heavy liquid cement flows over the guides 20 and down into the mold cavities forming legs 14. The guides 20 spanning the form are configured to prevent collapse or deformation during pouring. While the guides are shown in the figures to be wedged firmly against the form, such as along the “knee” of the form defined by the junction of legs 14 and panel 18, in alternate constructions, the guides may be placed in different positions.

After pouring, the concrete in the form is allowed to cure following which the form is stripped away from the beam. Guides 20 are retained in place at the top of the legs 14 immediately under the lower surface of panel 18. In another embodiment, guides 20 may be located at other positions in the form. After the concrete is completely cured and is set as part of a structure, commonly, a parking garage, conduits and wires are easily extended through the guides and neatly fastened to the undersurface of the top panel 18. In this way, the utilities are located out of the way and do not obstruct space between the dependent legs 14. The smooth interior surfaces 30 of the guide 20 and opposed flanges 24 assure that the elongate utility wires, conduits and the like may be easily threaded and pulled through the conduit guides without abrasion or injury by engaging rough concrete surfaces. As shown in FIG. 2, a pair of guides 20 may be located in the upper portions of adjacent legs 14 across from each other in order to facilitate stringing of a single conduit through both legs 14.

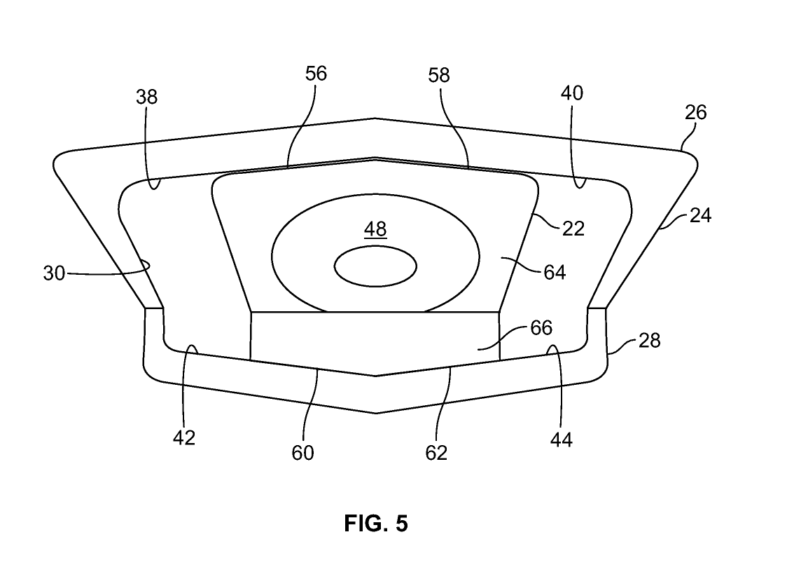

FIGS. 3-5 show an embodiment of positioner 22 for use with an exemplary embodiment of guide 20 having interior surface 30, including surface portions, such as upper surface portions 38, 40 and lower surface portions 42, 44. Positioner 22 includes upper surface portions 56, 58 that correspond to upper surface portions 38, 40 of guide 20. Similarly, positioner 22 includes lower surface portions 60, 62 that correspond to lower surface portions 42, 44 of guide 20. Stated another way, positioner 22 is configured for at least partial insertion into passage 36 of guide 20 so that the corresponding upper surface portions and lower surface portions of the guide and the positioner are brought into sufficiently close proximity with each other to substantially resist relative movement, other than in the direction of insertion, between the positioner and the guide. That is, while positioner 22 may be further inserted inside of guide 20, the corresponding upper and lower surfaces of the guide and positioner are configured to substantially reduce relative movement between the guide and the positioner in other directions. In one embodiment, the primary contacting surface portions are not upper or lower surface portions, but lateral surface portions corresponding to lateral surface portions of the guide, acting to reduce relative movement between the guide in the positioner in the lateral directions. It is to be understood that other constructions may be used in which surface features of the positioner and the guide are not configured to limit the relative movement between the positioner and the guide in the same manner, so long as an effective seal, such as a substantially fluid tight seal, is maintained between the ends of flanges of the guide and the pouring form. Optionally, a tapered region 68 may be formed in positioner 22 to more easily permit insertion of positioner 22 inside of guide 20.

It is to be understood that terms such as upper, lower and lateral are used to assist with understanding of the disclosure, and are not intended to be limiting.

As further shown in FIGS. 3-5, a body 46 of positioner 22 includes a ferromagnetic member 48 associated with the body. Ferromagnetic member 48 is configured to urge positioner 22 and the corresponding flanges 24 of one end of guide 20 toward form 12 or help maintain such close proximity therebetween to achieve an effective seal, such as a substantially fluid tight seal, between the guide flanges and the form. In one embodiment, ferromagnetic member 48 may be composed of the rare earth material, such as neodymium or samarium-cobalt. As shown, positioner 22 includes a surface 64 that is substantially coincident with ferromagnetic member 48. In addition, surface 64 is also substantially coincident with upper portion 26 of flange 24, or slightly recessed with respect to upper portion 26 of flange 24 when positioner 22 is in an installed position inside of guide 20, to achieve the desired effective seal between flange 24 and form 12. Optionally, a surface 66 of positioner 22 that is otherwise substantially coincident with lower portion 28 of flange 24 when positioner 22 is in an installed position inside of guide 20, may include a taper 54, providing an angular separation between surface 66 and a corresponding surface of form 12. This separation permits less precise tolerancing during the manufacture of the corresponding surface features between positioner 22 and a guide 20, while simultaneously providing an effective seal between flange 24 of guide 20 and form 12.

Optionally, ferromagnetic member 48 includes a gripping portion or handle 50 to permit ease of removal of the ferromagnetic member from form 12 once the form is open to release the cured T-beam (FIG. 1). In one embodiment, ferromagnetic member 48 is a magnet and form 12 is composed of a ferromagnetic material which may include rare earth ferromagnetic materials, which corresponding material of form 12 may also be magnetic such that the two magnets are oriented to attract each other. In another embodiment, only a corresponding portion of form 12 that is in close proximity with ferromagnetic member 48 is a magnet. In a yet further embodiment, form 12 is not composed of a ferromagnetic material, but an optional ferromagnetic member 52, which may be a magnet in a position exterior of or along the exterior surface of form 12, ultimately results in sufficiently drawing flange 24 of guide 20 toward form 12 in order to form an effective seal between form 12 and flange 24. In other words, one or more of ferromagnetic material 48, corresponding portion of form 12 and/or ferromagnetic member 52 may actually be magnetic, so long as flange 24 of guide 20 is sufficiently urged toward and/or maintained in sufficient close proximity with form 12 in order to achieve an effective seal with form 12.

In one embodiment, non-ferromagnetic material, including but not limited to a polymer material, may have ferromagnetic member 48 cast into it to form the positioner. In another embodiment, the entire positioner may be composed of a ferromagnetic material. In yet a further embodiment, a portion of the positioner is composed of a ferromagnetic material.

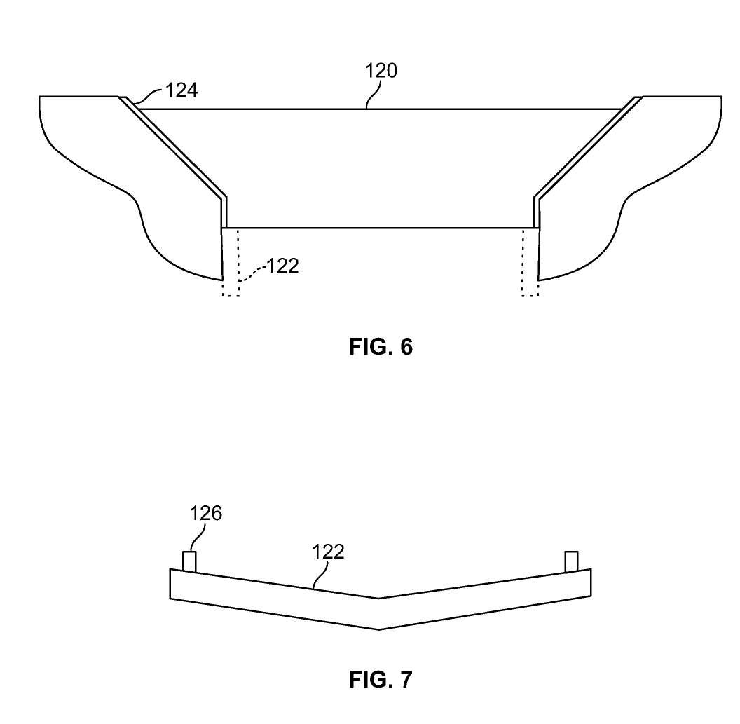

Referring to FIGS. 6-7, guide 120 which is similar to guide 20, includes flanges 124 that are similar to flanges 24, except that the segment of lower portion 28 beneath guide 120 has been removed. In the absence of the segment of lower portion 28, a positioner 122 having optional protrusions 126 may be used to position one end of guide 120 exterior of the guide. In one embodiment, positioner 122 includes a smooth and/or rounded profile to ensure that the elongate utility wires, conduits and the like may be easily threaded and pulled through the conduit guide without abrasion or injury by engaging rough concrete surfaces.

It is to be understood that a positioner such as exemplary embodiments of positioner 22, 122, which may be located interior of a conduit guide or exterior of a conduit guide, respectively, may be utilized to position one end of a conduit guide to a pouring form. It is to be further understood that other embodiments of the positioner may be configured to be simultaneously partially located interior of a conduit guide and exterior of a conduit guide, if desired, so long as the peripheral surfaces associated with the conduit guide would not cause abrasion or injury to the elongate utility wires, conduits and the like that may be threaded and pulled through the conduit guide.

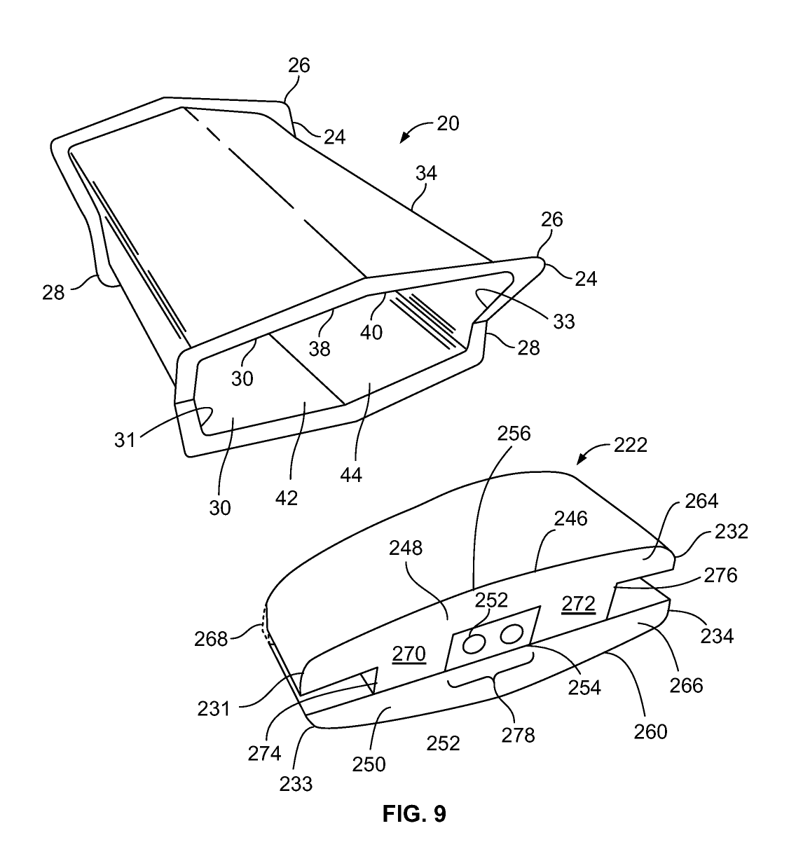

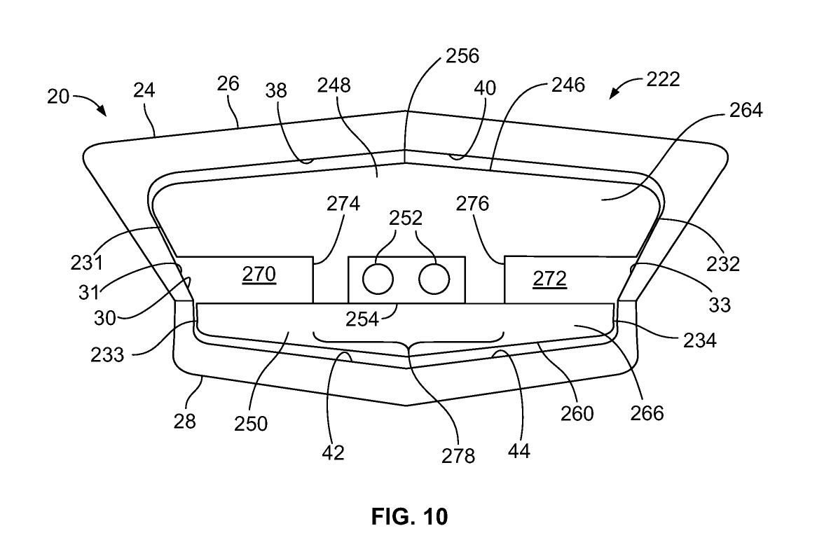

FIGS. 9-10 show an embodiment of positioner 222 for use with an exemplary embodiment of guide 20 having interior surface 30, including surface portions, such as upper surface portions 38, 40 and lower surface portions 42, 44. Positioner 222 includes a body 246 having an upper body portion 248 and an upper surface portion 246 that corresponds to upper surface portions 38, 40 of guide 20. Similarly, positioner 222 includes a lower body portion 250 having a lower surface portion 260 that corresponds to lower surface portions 42, 44 of guide 20. Stated another way, positioner 222 is configured for at least partial insertion into passage 36 of guide 20 so that the corresponding upper surface portion and lower surface portion of the guide and the positioner are brought into sufficiently close proximity with each other to substantially resist relative movement, other than in the direction of insertion, between the positioner and the guide. That is, while positioner 222 may be further inserted inside of guide 20, the corresponding upper and lower surfaces of the guide and positioner are configured to substantially reduce relative movement between the guide and the positioner in other directions. In one embodiment, the primary contacting surface portions of upper body portion 248 and lower body portion 250 with guide 20 is not upper surface portion 256 nor lower surface portion 260, but respective lateral surface portions 231, 232 and 233, 234, corresponding to respective lateral surface portions 31, 33 of the guide, acting to reduce relative movement between the guide in the positioner in the lateral directions. It is to be understood that other constructions may be used in which surface features of the positioner and the guide are not configured to limit the relative movement between the positioner and the guide in the same manner, so long as an effective seal, such as a substantially fluid tight seal, is maintained between the ends of flanges of the guide and the pouring form. Optionally, a tapered region 268 similar to tapered region 68 (FIG. 3) may be formed in positioner 222 to more easily permit insertion of positioner 222 inside of guide 20.

As further shown in FIGS. 9-10, spacings 270, 272 separating upper body portion 248 and lower body portion 250 extend inwardly from respective opposed lateral surface portions 231, 233 and 232, 234. Spacing 270 includes a gripping portion surface 274, and spacing 272 includes a gripping portion surface 276. Gripping portion surfaces 274, 276 collectively define a gripping portion 278, permitting manual removal of positioner 222 from guide 20, such as by directing an individual's thumb (not shown) into contact with gripping portion surface 274 and an individual's index finger (not shown) of the same hand of the individual into contact with gripping portion surface 276. Upon application of sufficient compressive forces by the individual's thumb and index finger against respective gripping portion surfaces 274, 276, in combination with a longitudinal retraction force that is substantially parallel with the passage 36 (FIG. 3) of guide 20, positioner 222 may be removed from guide 20.

It is to be understood that terms such as upper, lower and lateral are used to assist with understanding of the disclosure, and are not intended to be limiting.

As further shown in FIGS. 9-10, body 246 of positioner 222 include a pair of ferromagnetic members 252 associated with the body. Ferromagnetic members 252 are configured to urge positioner 222 and the corresponding flanges 24 of one end of guide 20 toward form 12 or help maintain such close proximity therebetween to achieve an effective seal, such as a substantially fluid tight seal, between the guide flanges and the form. In one embodiment, ferromagnetic members 252 may be composed of a rare earth material, such as neodymium or samarium-cobalt. Ferromagnetic members 252 may be secured to a plate 254 which is cast in body 246. As shown, positioner 222 includes a surface 264 that is substantially coincident with ferromagnetic members 252. In one embodiment, surface 264 is both coincident with ferromagnetic members 252 and plate 254. In addition, surface 264 is also substantially coincident with upper portion 26 of flange 24, or slightly recessed with respect to upper portion 26 of flange 24 when positioner 22 is in an installed position inside of guide 20, to achieve the desired effective seal between flange 24 and form 12. Optionally, a surface 266 of positioner 222 that is otherwise substantially coincident with lower portion 28 of flange 24 when positioner 222 is in an installed position inside of guide 20, may include a taper similar to taper 54 (FIG. 3), providing an angular separation between surface 266 and a corresponding surface of form 12. This separation permits less precise tolerancing during the manufacture of the corresponding surface features between positioner 222 and guide 20, while simultaneously providing an effective seal between flange 24 of guide 20 and form 12. Similarly, the construction of upper surface portion 256 and lower surface portion 260 permit less precise tolerancing during the manufacture of the corresponding surface features between positioner 222 and guide 20.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A positioner to secure a conduit guide in a cement pouring form for forming a concrete structural member, the positioner comprising:
a body having a surface portion configured and positioned to support a corresponding surface portion of the conduit guide in the form; and
a first ferromagnetic member associated with the body;
wherein the body selectably secures the conduit guide in the form without requiring a fastener.

2. The positioner of claim 1, wherein the body includes a tapered region.

3. The positioner of claim 1, wherein the body includes a tapered surface providing a spacing between the tapered surface and the corresponding surface of the form.

4. The positioner of claim 1, wherein the body is positionable interior of the conduit guide.

5. The positioner of claim 1, wherein the body is positionable exterior of the conduit guide.

6. The positioner of claim 1, wherein the first ferromagnetic member is cast in the body.

7. The positioner of claim 1, wherein the body is at least partially composed of ferromagnetic material.

8. The positioner of claim 1, including a second ferromagnetic member positioned exterior of the form and corresponding to the first ferromagnetic member to secure the conduit guide to a form composed of a non-ferromagnetic material.

9. The positioner of claim 1, wherein the first ferromagnetic member is composed of a rare earth material.

10. The positioner of claim 9, wherein the rate earth material is composed of at least one of neodymium and samarium-cobalt.

11. The positioner of claim 1, wherein the body is reusable.

12. The positioner of claim 1, wherein the body includes a gripping portion, permitting manual removal of the body from the conduit guide.

13. A method of positioning a conduit guide in a pouring form comprising:
providing a positioner having a body and a surface portion, the body associated with a first ferromagnetic member;
selectably positioning the surface portion of the body and a surface portion of the conduit guide to support the conduit guide in the form without requiring a fastener.

14. The method of claim 13, further comprising positioning a second ferromagnetic member exterior of the form and corresponding to the first ferromagnetic member to secure the conduit guide to a form composed of a non-ferromagnetic material.

15. The method of claim 13, wherein the body is selectably positioned interior of the conduit guide.

16. The method of claim 13, wherein the body is selectably positioned exterior of the conduit guide.

17. The method of claim 13, wherein the first ferromagnetic member is cast in the body.

18. The method of claim 13, wherein the first ferromagnetic material is composed of the rare earth material.

19. The method of claim 13, wherein the body is reusable.

20. A positioner to secure a conduit guide in a cement pouring form for forming a concrete structural member, the positioner comprising:
a body having at least one surface portion, each surface portion configured and positioned to support a corresponding surface portion of the conduit guide in the form, the corresponding surface portions opposed to each other; and
a first ferromagnetic member associated with the body;
wherein the body selectably secures the conduit guide in the form without requiring a fastener;
wherein the body is reusable.
